(19) United States
(12) Patent Application Publication
(10) Pub. No.: US 2017/0183155 A1
(43) Pub. Date: Jun. 29, 2017

(54) CONVEYING VEHICLE AND CONVEYING SYSTEM

(71) Applicant: Hitachi, Ltd., Tokyo (JP)

(72) Inventors: Yoriko KAZAMA, Tokyo (JP); Junichi KIMURA, Tokyo (JP)

(21) Appl. No.: 15/309,577

(22) PCT Filed: Dec. 26, 2014
(86) PCT No.: PCT/JP2014/084533

§ 371 Date: Nov. 8, 2016

(51) Int. Cl. B65G 1/04; G05D 1/02

(52) U.S. Cl. CPC B65G 1/0492; G05D 1/0287; G05D 2201/0216

(57) ABSTRACT

A conveying vehicle that loads an article thereon and moves includes an attachment fitting portion into which an attachment having a predetermined function is fitted, a memory device that stores determination criteria as to the presence or absence of a restriction on the movement of the conveying vehicle corresponding to the attribute of the attachment, a reception unit that receives information related to the attribute of the attachment from the attachment fitted into the attachment fitting portion, a determination unit that determines whether the restriction on the movement of the conveying vehicle is required, based on the determination criteria corresponding to the attribute of the attachment identified from the information received by the reception unit, and a control unit that controls the movement of the conveying vehicle according to the restriction when it is determined that the restriction is required.

### TECHNICAL FIELD

The present invention relates to a conveying vehicle that conveys an article stored in a warehouse and a conveying system including the conveying vehicle.

### BACKGROUND ART

Articles to be worked vary in type and amount according to a working day or working time, and there is a possibility that this cannot be coped with by a fixed number of conveying vehicles or material handling apparatuses, such as belt conveyors. Accordingly, disclosed is a technique in which an apparatus attached to a conveying vehicle for handling an article is allowed to be replaced so as to be attached according to the article to be conveyed.

For example, Patent Literature 1 discloses a technique in which a lifter is attached as an attachment to a conveying vehicle, and the type of the lifter is changed according to the size of an article to be conveyed.

In addition, disclosed is a technique in which information is obtained from a sensor of an apparatus attached to a conveying vehicle, and is transmitted to the conveying vehicle.

For example, Patent Literature 2 discloses a technique in which a robot arm is attached to a conveying vehicle to transmit, to the conveying vehicle, information of a camera attached to the robot arm.

### CITATION LIST

### Patent Literature

Patent Literature 1: Japanese Unexamined Patent Application Publication No. Hei 9-272430
Patent Literature 2: U.S. Pat. No. 3,333,963

### SUMMARY OF INVENTION

### Technical Problem

To attach an attachment to a conveying vehicle, the conveying vehicle is required to have performance that optimally drives all of various attachments. For this, in a state where a particular attachment is attached to a conveying vehicle, the performance of the conveying vehicle is required to be restricted in part. However, the restriction imposed on the conveying vehicle is not found until the attachment is attached to the conveying vehicle.

However, according to the technique described in Patent Literature 1, a measurement device such as a sensor is not mounted on the attachment, and the attachment apparatus is operated according to the instruction of the conveying vehicle. Consequently, the performance of the conveying vehicle cannot be changed according to the attachment.

In addition, according to the technique described in Patent Literature 2, it is not assumed that the robot arm attached to the conveying vehicle is separated from the conveying vehicle, and the control of the performance and traveling of the conveying vehicle is optimized for the work of the robot arm. Consequently, when the attachment is replaced, the conveying vehicle cannot carry out optimal control according to the attachment.

Accordingly, an object of the present invention is to provide a conveying vehicle that can removably attach a plurality of attachments thereto and has a function of restricting its function according to each attached attachment.

### Solution to Problem

To solve the above problems, an aspect of the present invention provides a conveying vehicle that loads an article thereon and moves, including an attachment fitting portion into which an attachment having a predetermined function is fitted, a memory device that stores determination criteria as to the presence or absence of a restriction on the movement of the conveying vehicle corresponding to the attribute of the attachment, a reception unit that receives information related to the attribute of the attachment from the attachment fitted into the attachment fitting portion, a determination unit that determines whether or not the restriction on the movement of the conveying vehicle is required, based on the determination criteria corresponding to the attribute of the attachment identified from the information received by the reception unit, and a control unit that controls the movement of the conveying vehicle according to the restriction when it is determined that the restriction is required, wherein the memory device further includes map information, wherein the determination criteria corresponding to the attribute of the attachment include information that associates the size of an article loaded on the conveying vehicle with information as to whether or not the conveying vehicle can pass through a path included in the map information, wherein the reception unit receives information related to the size of the article from the attachment, wherein the determination unit determines whether or not the conveying vehicle can pass through the path included in the map information, based on the size of the article identified based on the information received by the reception unit and the determination criteria, and transmits position information that indicates a position through which the conveying vehicle can pass, and wherein control unit restricts the path through which the conveying vehicle moves based on the position information.

### Advantageous Effects of Invention

According to the present invention, various attachments can be removably attached to the conveying vehicle, and the control of the conveying vehicle can be restricted according to the attached attachment. This enables an operation suitable for the attached attachment. Other problems, configurations, and effects will be apparent from the description of the following embodiments.

### BRIEF DESCRIPTION OF DRAWINGS

FIG. 1A is a function block diagram illustrating the configuration of a conveying system according to an embodiment of the present invention.

FIG. 1B is a block diagram illustrating the hardware configuration of the conveying system according to the embodiment of the present invention.

FIG. 2 is a flowchart illustrating a process executed by a conveying vehicle according to a first embodiment of the present invention.

FIG. 3 is an explanatory view illustrating an example in which a lifter is attached as an attachment to the conveying vehicle according to the first embodiment of the present invention.

FIG. 4 is an explanatory view of determination as to whether or not a conveying vehicle can pass according to a second embodiment of the present invention.

FIG. 5 is a block diagram illustrating the hardware configuration of a controller according to a third embodiment of the present invention.

FIG. 6 is a function block diagram illustrating the configuration of a conveying system according to the third embodiment of the present invention.

FIG. 7 is a conceptual diagram illustrating the operation of a conveying vehicle according to a fourth embodiment of the present invention.

FIG. 8 is a sequence diagram illustrating communication between the conveying vehicle, the attachment, and the controller according to the fourth embodiment of the present invention.

FIG. 9 is a function block diagram illustrating the configuration of a conveying system according to a fifth embodiment of the present invention.

FIG. 10 is an explanatory view of the center of gravity when one or more attachments are attached to a conveying vehicle according to the fifth embodiment of the present invention.

### DESCRIPTION OF EMBODIMENTS

Each embodiment of the present invention (hereinafter, referred to as “this embodiment”) will be described in detail with reference to the drawings, as needed.

Overview

First, the overview of a conveying system will be described.

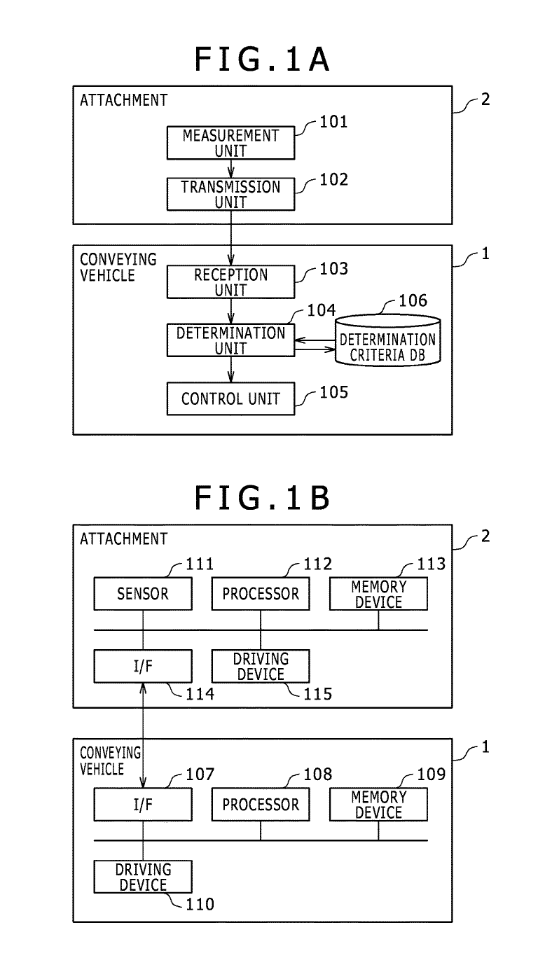

FIG. 1A is a function block diagram illustrating the configuration of the conveying system according to an embodiment of the present invention.

The conveying system includes a conveying vehicle 1 and an attachment 2. The conveying vehicle 1 and the attachment 2 can communicate with each other by wire or wirelessly. The attachment 2 does not have a restriction on its function if it is attachable to the conveying vehicle. The attachment 2 has some function for conveying an article, and examples of the attachment 2 include a robot arm that holds (or absorbs) and moves the article, a lifter that lifts the article, a belt conveyor that places the article thereon and laterally moves it, and a seat that places thereon a working person engaged in conveying the article, but the attachment 2 is not limited to these. The conveying vehicle 1 can attach thereto the attachment 2 having a given function and move. In the following description, the article placed (or loaded) on the attachment 2 is the article to be worked by the attachment 2, such as the article held by the robot arm, the article lifted by the lifter, or the article placed on and moved by the belt conveyor. In addition, when the attachment 2 is the seat, the article described below is replaced by the person sitting on the seat.

Referring to FIG. 1A, the function of the conveying system will be described.

The attachment 2 has a measurement unit 101 that measures the attachment 2 and the article to be worked. The measurement result is transmitted via a transmission unit 102 to the conveying vehicle 1.

The conveying vehicle 1 has a reception unit 103 that receives the information transmitted from the attachment.

A determination unit 104 compares the information received by the reception unit 103 with determination criteria stored in a determination criteria database (DB) 106, and determines whether the performance of the conveying vehicle 1 is restricted. The determination criteria DB 106 stores, for each attribute (e.g., type) of the attachment 2, the determination criteria as to whether performance related to the movement of the conveying vehicle 1 to which the attachment 2 having the attribute is attached (e.g., a moving speed, an acceleration, a moving distance, a distance between the conveying vehicle 1 and another conveying vehicle 1, or a path through which the conveying vehicle 1 can pass) is restricted. The detail of the determination criteria will be described later.

When the determination unit 104 determines that the performance of the conveying vehicle 1 is restricted, a control unit 105 receives a restriction condition from the determination unit 104, and carries out control to restrict the performance of the conveying vehicle 1 according to the received restriction condition.

FIG. 1B is a block diagram illustrating the hardware configuration of the conveying system according to the embodiment of the present invention.

The attachment 2 has a sensor 111, a processor 112, a memory device 113, an interface (I/F) 114, and a driving device 115, which are mutually connected. The sensor 111 is used for measuring the attachment 2 and an article to be worked, and may be, e.g., a weight sensor, camera, or laser sensor. The interface 114 communicates with the conveying vehicle 1 by wire or wirelessly. The driving device 115 carries out an operation for achieving the function of the attachment 2. For example, when the attachment 2 is a lifter or a robot arm driven by a motor, the driving device 115 may include the motor and its control circuit.

The processor 112 executes a program stored in the memory device 113, and controls the sensor 111, the memory device 113, the interface 114, and the driving device 115, as needed, to achieve various functions. For example, the measurement unit 101 has a function achieved in such a manner that the processor 112 controls the sensor 111, and the transmission unit 102 has a function achieved in such a manner that the processor 112 controls the interface 114.

The memory device 113 may include a volatile memory device, such as a DRAM (Dynamic Random Access Memory), and a non-volatile memory device, such as a flash memory, and may store the program executed by the processor 112 to achieve various functions, data used for a process for achieving the functions, measurement data of the sensor 111, and identification information and attribute information of the attachment 2.

In the example of FIG. 1B, the general-purpose processor 112 executes the program to achieve various functions, but these functions can be achieved by an exclusive logic circuit.

The conveying vehicle 1 has an interface 107, a processor 108, a memory device 109, and a driving device 110, which are mutually connected. The interface 107 communicates with the attachment 2 by wire or wirelessly. The driving device 110 is a device that moves the conveying vehicle 1, and may include, e.g., a plurality of wheels, a motor that drives the wheels, a battery that supplies electric power to the motor, and a control circuit that controls them.

The processor 108 executes a program stored in the memory device 109, and controls the memory device 109, the interface 107, and the driving device 110, as needed, to achieve various functions. For example, the reception unit 103 has a function achieved in such a manner that the processor 108 controls the interface 107, the determination unit 104 has a function achieved by the processor 108 based on data stored in the memory device 109, and the control unit 105 has a function achieved in such a manner that the processor 108 controls the driving device 110. A function in which the determination unit 104 transmits performance information to the attachment 2 in a fifth embodiment described later is achieved in such a manner that the processor 108 controls the interface 107.

The memory device 109 may include a volatile memory device, such as a DRAM, and a non-volatile memory device, such as a flash memory, and stores the program executed by the processor 108 to achieve various functions, and data used for a process for achieving the functions (e.g., the determination criteria database 106).

### First Embodiment

The function example of a conveying system according to a first embodiment of the present invention will be described with reference to FIGS. 1A, 1B, 2, and 3.

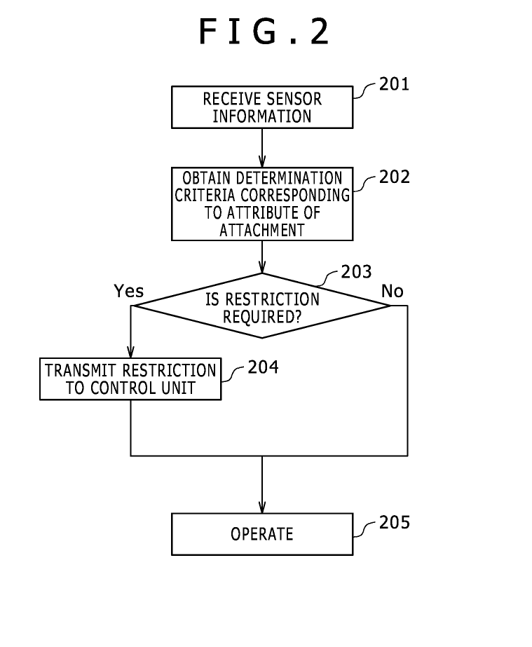

FIG. 2 is a flowchart illustrating a process executed by the conveying vehicle according to the first embodiment of the present invention.

When an article is placed on the attachment 2 (for example, when the article is placed on a lifter, or when a robot arm holds and lifts the article), first, the measurement unit 101 of the attachment 2 measures the article, and the transmission unit 102 transmits the measurement result (that is, sensor information) to the conveying vehicle 1. Further, the transmission unit 102 transmits, to the conveying vehicle, information related to the attribute of the attachment 2 stored in the memory device 113. The information related to the attribute of the attachment 2 may be information that identifies the attribute itself, such as the type, function, shape, size, weight, and application of the attachment 2, but when the conveying vehicle 1 holds information that associates identification information of the attachment 2 with its attribute, the information related to the attribute of the attachment 2 may be the identification information of the attachment 2. Here, an example in which the transmission unit 102 transmits the information related to the attribute together with the sensor information is shown, but the transmission unit 102 may transmit the information related to the attribute in a period different from the transmission period of the sensor information (e.g., when the attachment 2 is attached to the conveying vehicle 1 and activated).

When the reception unit 103 of the conveying vehicle 1 receives the sensor information and the information related to the attribute from the transmission unit 102 of the attachment 2 (step 201), it transmits the received information to the determination unit 104. The determination unit 104 identifies the attribute of the attachment 2 based on the received information, obtains determination criteria corresponding to the attribute from the determination criteria DB 106 (step 202), and determines whether or not the performance is required to be restricted, based on the obtained determination criteria and the received sensor information (step 203).

When the determination unit 104 determines that the performance is required to be restricted, it transmits a necessary restriction to the control unit 105 (step 204), and when the determination unit 104 determines that the performance is not required to be restricted, it does not transmit the necessary restriction to the control unit 105. When the control unit 105 receives the restriction, it controls the operation of the conveying vehicle 1 according to the restriction, and when the control unit 105 does not receive the restriction, it controls the operation of the conveying vehicle 1 without the restriction (step 205).

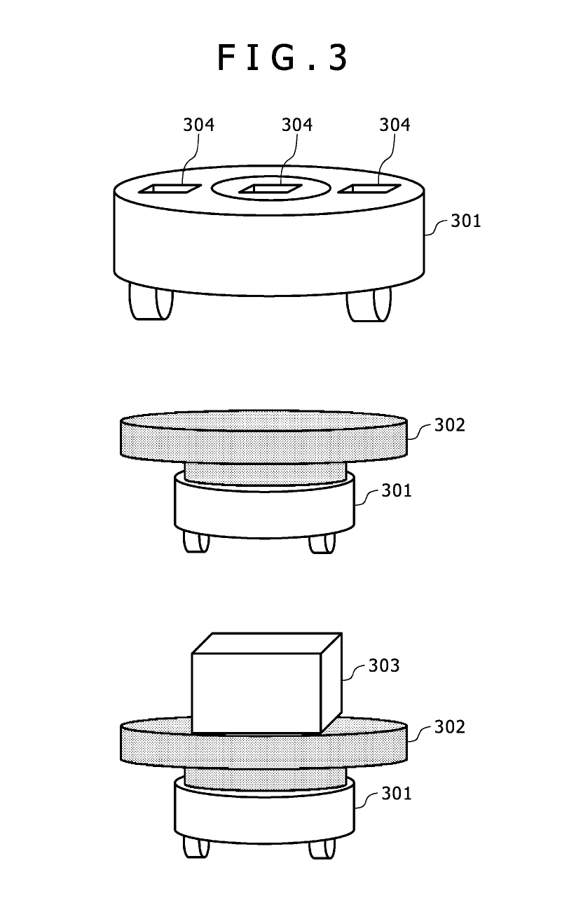

FIG. 3 is an explanatory view illustrating an example in which a lifter is attached as the attachment to the conveying vehicle according to the first embodiment of the present invention.

A conveying vehicle 301 illustrated in FIG. 3 corresponds to the conveying vehicle 1 in FIG. 1A. The conveying vehicle 301 has one or more (three in the example in FIG. 3) attachment fitting portions 304. One attachment 2 that can be independently used can be fitted into one attachment fitting portion 304. When as illustrated in FIG. 3, the conveying vehicle 301 has a plurality of attachment fitting portions 304, the attachments 2 of the same type or of types different from each other may be fitted into the attachment fitting portions 304. One attachment 2 may be attached by using a plurality of attachment fitting portions 304 according to the shape or size of the attachment 2.

For example, the attachment 2 may be attached to the conveying vehicle 301 in such a manner that each attachment fitting portion 304 has a concave portion in a predetermined shape, and the convex portion of the attachment is fitted into the concave portion. In addition, when the conveying vehicle 301 and the attachment 2 communicate with each other by wire, the attachment 2 may include an electric connector for communication. However, the shape and fitting method of the attachment fitting portions 304 are given by way of example, and as long as various attachments 2 can be replaceably fitted into each attachment fitting portion 304, any shape and fitting method may be adopted.

A lifter 302 is attached as the attachment 2 to the conveying vehicle 301, and a weight measurement device (not illustrated in FIG. 3) that measures the weight of an article 303 loaded thereon is mounted on the lifter 302. The measurement device corresponds to the measurement unit 101 in FIG. 1A and the sensor 111 in FIG. 1B. The conveying vehicle 301 places the article 303 on the lifter 302 to convey it. The lifter, which holds the article 303, vertically moves according to a work instruction. In the first embodiment, a case where a restriction is imposed on the speed performance of the conveying vehicle according to the weight of the article 303 conveyed will be described.

When the article 303 is placed on the lifter 302 as the attachment 2, the measurement unit 101 of the lifter 302 measures the weight of the article, and transmits the measurement result from the transmission unit 102 to the conveying vehicle 301. Here, the lifter 302 may transmit the weight itself of the measured article, or may transmit only a determination value as to whether or not the weight is equal to or above a predetermined threshold value. Further, the lifter 302 transmits information related to the attribute of the lifter 302.

The reception unit 103 of the conveying vehicle 301 receives the weight information and the information related to the attribute from the transmission unit 102 (step 201), and transmits the received information to the determination unit 104. The determination unit 104 identifies the attribute of the lifter 302 based on the received information related to the attribute, and obtains, from the determination criteria DB 106, determination criteria corresponding to the identified attribute (step 202). Here, an example in which determination criteria for each type of the attachment as one attribute of the attachment are stored in the determination criteria DB 106 will be described.

The determination unit 104 receives the information related to the attribute of the attachment, from the lifter 302 as the attachment attached to the conveying vehicle 301 in step 201, and when the information includes information representing that the type of the attachment is the lifter, the determination unit 104 can identify the type of the attached attachment as the lifter based on that. Alternatively, when the received information related to the attribute of the attachment includes the identification information of the attachment, the determination unit 104 may identify the type of the attachment as the lifter based on information that associates the identification information of the attachment with the attribute of the attachment. Then, the determination unit 104 obtains determination criteria corresponding to the lifter from the determination criteria DB 106.

The obtained determination criteria includes, e.g., information that associates the weight of the article 303 placed on the lifter 302 with a restriction on a traveling speed as one performance of the conveying vehicle 301. Specifically, for example, when the weight of the article 303 exceeds the predetermined threshold value, in order to restrict the moving speed of the conveying vehicle 301, the determination criteria may include information that instructs the upper limit of the moving speed (that is, a restricted speed). In that case, the determination unit 104 determines whether or not the weight of the article 303 identified from the received sensor information exceeds the predetermined threshold value (step 203), and when the weight of the article 303 identified from the received sensor information exceeds the predetermined threshold value, the restricted speed is transmitted as a restriction on the performance to the control unit 105 (step 204).

The control unit 105 that has received this restriction controls the driving device 110 to prevent the conveying vehicle 301 from exceeding the received restricted speed and from moving at high speed. This can move the conveying vehicle 301 at low speed without dropping the article 303, and can reduce the load of the attachment 2 caused by the weight and acceleration of the article 303.

In the example of the determination criteria, different values can be set as the threshold value of the weight of the article according to the type of the attachment 2, and different values can be set to the restricted speed corresponding to the respective threshold values. For example, as the withstand load of the attachment 2 is increased and its configuration is harder to drop the article, a higher value may be set as the threshold value of the weight of the article, or a higher value may be set as the restricted speed corresponding to the threshold value. In addition, the predetermined restricted speed may be set regardless of the weight of the placed article according to the application of the attachment 2. This can optimally control the movement of the conveying vehicle 1 according to the attribute of the attachment 2 and the placed article. Further, by the same method, the acceleration of the conveying vehicle 1 may be restricted according to the attribute of the attachment and the weight of the article. In that case, the determination criteria DB 106 include information representing the upper limit of the acceleration corresponding to the attribute of the attachment 2 (that may be a fixed value regardless of the weight of the article, or a value according to the weight of the article).

In the example of the determination criteria, the restricted speed is set according to one threshold value, but may be set stepwise corresponding to a plurality of threshold values, or may be continuously set according to the weight of the article without providing the threshold value. Alternatively, a plurality of threshold values may be set stepwise so that the restricted speed between the threshold values may be continuously set according to the weight of the article. In these examples, the restricted speed is set low when the article placed on the attachment 2 is heavy, so that the article can be prevented from being dropped and the load of the attachment 2 can be reduced.

### Second Embodiment

In the first embodiment, the example in which a restriction is imposed on the speed performance of the vehicle according to the weight of an article conveyed has been described. In a second embodiment, an example in which a restriction is imposed on a path through which the conveying vehicle moves, according to the size of an article conveyed will be described. Except for the differences described below, the portions of a conveying system of the second embodiment have the same functions as the portions indicated by the same reference numerals of the first embodiment illustrated in FIGS. 1 to 3, and their description is omitted.

To the conveying vehicle 1 of the second embodiment, a belt conveyor or a lifter is attached as the attachment 2, and a measurement device that measures the size of the article conveyed is mounted as the sensor 111 on the attachment 2. The measurement device is, e.g., a camera or laser sensor.

The measurement unit 101 of the attachment 2 measures the size of the article placed on the attachment. In addition, the measurement unit 101 may compare the width of the attachment 2 with the width of the article, determining whether the width of the article is larger or smaller than the width of the attachment 2. The measurement unit 101 notifies the measured size of the article to the transmission unit 102. The transmission unit 102 transmits the notified size of the article to the conveying vehicle 1.

The reception unit 103 of the conveying vehicle 1 receives the size of the article transmitted from the attachment 2 (step 201), and notifies it to the determination unit 104. Like the first embodiment, information related to the attribute of the attachment 2 is transmitted from the transmission unit 102 of the attachment 2 to the conveying vehicle 1, and is transmitted from the reception unit 103 of the conveying vehicle 1 to the determination unit 104.

The determination criteria DB 106 of the second embodiment stores map information of a region in which the conveying vehicle 1 moves (for example, a warehouse in which the conveying vehicle 1 is used). The determination unit 104 reads out determination criteria according to the attribute of the attachment 2 from the determination criteria DB 106 (step 202).

In the second embodiment, the determination unit 104 reads out, from the determination criteria DB 106, the map information of the region in which the conveying vehicle 1 moves, as the determination criteria. The read-out map information may describe the size of a moving body that can move in a space that can be the moving path of the conveying vehicle 1 (or that includes all of the conveying vehicle 1, the attachment 2 attached to the conveying vehicle 1, and the article placed on the attachment 2), may describe information that describes the size of equipment installed in the space so that the size of the moving body that can pass under or sidewise of the equipment can be discriminated, or may describe information representing the size of the article that is placed on the attachment 2 and can move in each space.

The determination unit 104 determines the path through which the conveying vehicle 1 can pass, based on the map information and the size of the article held by the attachment. For example, when as described above, the size of the moving body that can move is described, the determination unit 104 compares the size of an entire moving body including the conveying vehicle 1, the attachment 2 attached thereto, and the article placed thereon, with the size of the moving body described in the determination criteria DB 106, and determines, based on the result, the path through which the conveying vehicle 1 can pass.

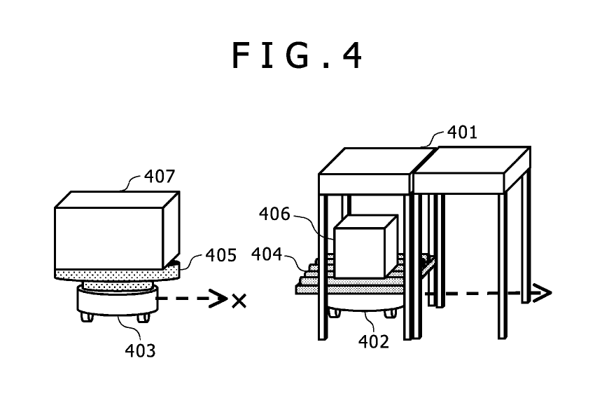

FIG. 4 is an explanatory view of determination as to whether or not the conveying vehicle 1 can pass according to the second embodiment of the present invention.

Conveying vehicles 402 and 403 illustrated in FIG. 4 correspond to the conveying vehicle 1 in FIG. 1A. A belt conveyor 404 and a lifter 405 correspond to the attachment 2 in FIG. 1A. An article 406 is placed on the belt conveyor 404, and an article 407 is placed on the lifter 405. In addition, a rack 401 is installed in a space in which the conveying vehicle moves, and map information includes information that identifies the installation position of the rack 401 and the size of an object that can pass thereunder.

For example, due to the belt conveyor 404 and the lifter 405 being different in shape or size, the size (e.g., height) of the articles that are placed thereon and can pass under the rack 401 can be different. In that case, the size of the article that can pass under the rack 401, included in the map information read out by the determination unit 104 of the conveying vehicle 402, is different from the size of the article that can pass under the rack 401, included in the map information read out by the determination unit 104 of the conveying vehicle 403. In the example in FIG. 4, the determination unit 104 of the conveying vehicle 402 determines that the conveying vehicle 402 can pass under the rack 401, based on the size of the article 406 and the map information, and the determination unit 104 of the conveying vehicle 403 determines that the conveying vehicle 403 cannot pass under the rack 401, based on the size of the article 407 and the map information. In step 203, in the former, it is determined that a restriction on the space under the rack 401 is not required, while in the latter, it is determined that a restriction on the space under the rack 401 is required. The restriction (that is, the conveying vehicle 403 cannot pass under the rack 401) is transmitted to the control unit 105 (step 204).

In addition, according to the shape or size of the attachment 2, there is a possibility that the conveying vehicle 1 cannot pass under the rack 401 regardless of the size of the article placed. The map information corresponding to such attachment 2 includes information representing that the conveying vehicle 1 cannot pass through the space under the rack 401, and based on that, it is determined that it cannot pass under the rack 401.

The control unit 105 receives position information in which the conveying vehicle 1 can pass, obtained from the determination unit 104, and imposes a restriction on the moving path of the conveying vehicle 1 in order that the conveying vehicle 1 moves only in the position in which the conveying vehicle 1 can pass, to carry out conveyance (step 205).

As described above, the moving path of the conveying vehicle 1 is restricted according to the size of the attachment 2 and the article loaded thereon, so that the optimal moving path can be selected.

### Third Embodiment

In a third embodiment, an example in which a conveying system has a controller 3, and the conveying vehicle 1 and the attachment 2 are operated according to a work instruction from the controller 3 will be described. Except for the differences described below, the portions of the conveying system of the third embodiment have the same functions as the portions indicated by the same reference numerals of the first and second embodiments illustrated in FIGS. 1 to 4, and their description is omitted. In addition, the conveying vehicle 1 of the third embodiment attaches a robot arm thereto as the attachment 2. Further, the moving region of the conveying vehicle 1 is previously defined as a map, and is managed by coordinates XY.

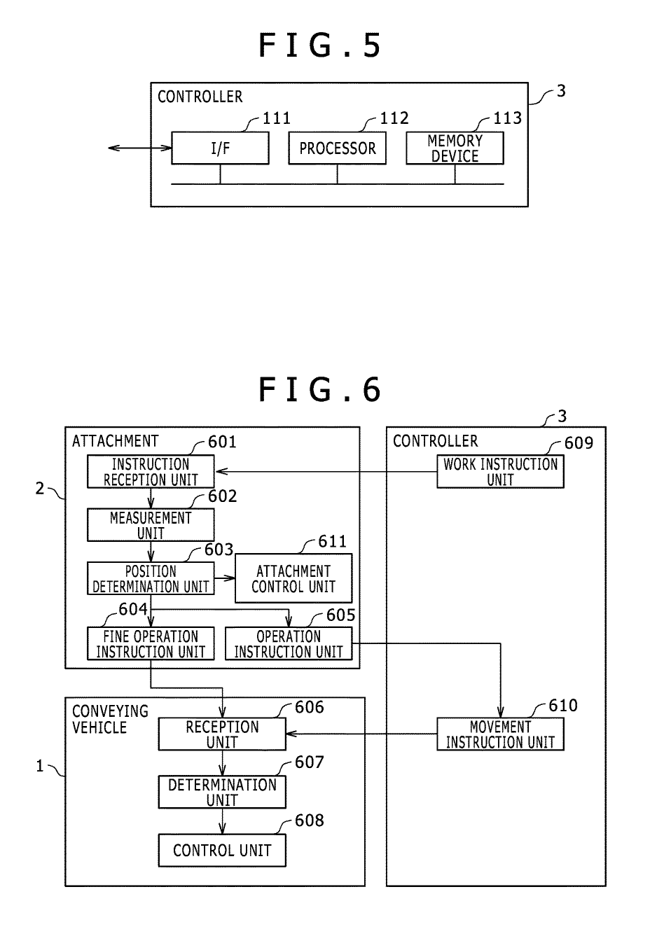

FIG. 5 is a block diagram illustrating the hardware configuration of the controller 3 according to the third embodiment of the present invention.

In the third embodiment, the movement of the conveying vehicle 1 is controlled by the controller 3. The controller 3 is, e.g., a calculator that has an interface 501, a processor 502, and a memory device 503. The interface 501 communicates with the conveying vehicle 1 and the attachment 2 by wire or wirelessly. The processor 502 executes a program stored in the memory device 503, and controls the interface 501, as needed, thereby achieving the functions of a work instruction unit 609 and a movement instruction unit 610 described later.

The memory device 503 may include a volatile memory device, such as a DRAM, and a non-volatile memory device, such as a hard disk drive, and the processor 502 stores a program executed by the processor 502 to achieve various functions, and data used for a process for achieving the functions.

The hardware configuration of the conveying vehicle 1 and the attachment 2 of this embodiment is the same as the first embodiment, and the description is omitted (see FIG. 1B).

FIG. 6 is a function block diagram illustrating the configuration of the conveying system according to the third embodiment of the present invention.

The conveying vehicle 1 has a reception unit 606, a determination unit 607, and a control unit 608. Like the reception unit 103, the determination unit 104, and the control unit 105 of the first embodiment, these may be achieved in such a manner that the processor 108 executes the program stored in the memory device 109 and the units of the conveying vehicle 1 are controlled, as needed, or may be achieved by the control of an exclusive logic circuit.

The attachment 2 has an instruction reception unit 601, a measurement unit 602, a position determination unit 603, a fine operation instruction unit 604, an operation instruction unit 605, and an attachment control unit 611. Like the measurement unit 101 and the transmission unit 102 of the first embodiment, these may be achieved in such a manner that the processor 112 executes the program stored in the memory device 113 and the units of the attachment 2 are controlled, as needed, or may be achieved by the control of an exclusive logic circuit.

The attachment control unit 611 has a function of controlling the original operation of the attachment 2, e.g., an operation in which a robot arm holds and moves an article, or an operation in which a lifter lifts the article. This function is achieved, for example, in such a manner that the processor 112 controls the driving device 115 according to the program. Although not illustrated in FIG. 1A, the attachment 2 of other embodiments has the same function as the attachment control unit 611.

The controller 3 is a control device that has the movement instruction unit 610 that instructs movement to the conveying vehicle 1, and the work instruction unit 609 that instructs the work to the attachment 2. In the example in FIG. 6, one controller 3 controls one conveying vehicle 1 and one attachment 2 attached thereto, but can actually control a plurality of conveying vehicles 1 used in, e.g., a warehouse and a plurality of attachments 2 attached thereto. Typically, for example, the controller 3 may be installed in a predetermined position in the warehouse, transmitting a movement instruction and a work instruction by wireless communication to the plurality of conveying vehicles and attachments in the warehouse.

The movement instruction unit 610 transmits the movement instruction to the conveying vehicle 1. The movement instruction includes the coordinate values (X, Y) of a destination.

The reception unit 606 of the conveying vehicle 1 receives the movement instruction from the controller 3. The determination unit 607 determines the instructed position of the destination, and determines that when the coordinate values of the current position of the conveying vehicle 1 and the coordinate values of the position of the destination are not the same, the conveying vehicle 1 is required to be moved. When the conveying vehicle 1 is required to be moved, the reception unit 606 notifies the coordinate values of the destination to the control unit 608. The control unit 608 carries out control for moving the conveying vehicle 1 to the received coordinate values.

When the conveying vehicle 1 reaches the destination instructed by the movement instruction unit 610, the work instruction unit 609 of the controller 3 transmits the work instruction to the attachment 2. Here, for example, when the attachment 2 is the robot arm, the work instruction to the attachment 2 is the instruction for the article held by the robot arm and the number of articles.

The instruction reception unit 601 receives the work instruction from the controller 3, and notifies the work to the measurement unit 602. The measurement unit 602 measures the position of the article to be worked. For measurement, the mounted sensor 111 such as a camera is used. The measurement unit 602 calculates the position of the article by the camera, and measures a relative distance from the sensor 111 such as a camera to the article.

The position determination unit 603 determines, based on the measurement result by the measurement unit 602, whether the article to be worked is within the operation range of the robot arm. For this, information representing the operation range of the attachment 2 (in the case of the robot arm having a hand holding the article, the range reached by the hand) is stored in the memory device 113 of the attachment 2, and is referred by the position determination unit 603.

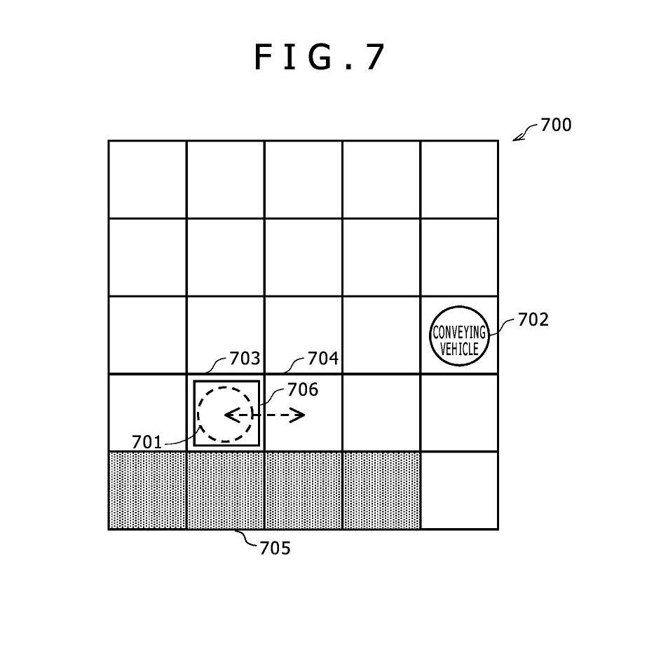

When the article is within the operation range of the robot arm, the attachment control unit 611 directly executes the work in which the article is held by the robot arm. When the article is outside the operation range of the robot arm, the position determination unit 603 calculates a distance from the attachment 2 to the article, and determines whether the calculated distance is within the resolution of the coordinate values that can be designated by the movement instruction unit 610. For example, when the movement instruction unit 610 can designate the coordinate values of a destination at an interval of 1 m, but cannot instruct the coordinate values of the destination at an interval less than 1 m, the resolution of the coordinate values is 1 m, so that it is determined whether the calculated distance is within 1 m. For example, when the space in the warehouse is divided and managed into grids having each side of 1 m and the coordinate values of the grid of the destination are included in the movement instruction, the resolution of the coordinate values is 1 m. An example of the grid will be described later with reference to FIG. 7.

When the calculated distance is within the resolution of the coordinate values, the fine operation instruction unit 604 notifies, to the conveying vehicle 1, the direction of the article and the distance to the article. The operation instruction unit 605 notifies, to the controller 3, that the position of the conveying vehicle 1 is being finely adjusted. When the distance to the article is equal to or above the coordinate values, the operation instruction unit 605 notifies, to the movement instruction unit 610, the coordinate values of the position in which the distance to the article is minimum (e.g., the coordinate values of the grid closest to the article), based on the distance measured by the measurement unit 602. The movement instruction unit 610 that has received the notification transmits, to the reception unit 606, the movement instruction including the notified coordinate values.

The reception unit 606 can receive, from the controller 3, the movement instruction including the coordinate values of the destination, and can receive, from the fine operation instruction unit 604, the movement instruction with respect to a resolution less than the resolution of the coordinate values designated from the controller 3 (e.g., on the order of cm). The control unit 105 can execute movement at a distance of 1 m or movement at a distance less than 1 m in the direction approaching the article to be worked according to these movement instructions.

As described above, the attachment 2 instructs movement at the distance less than the resolution of the coordinate values of the movement instruction from the controller 3, to the conveying vehicle 1 not via the controller 3. Thus, while reducing the communication load between the controller 3 and the conveying vehicle 1, the conveying vehicle 1 can carry out the operation suitable for the work of the attachment 2.

In the above example, according to whether or not the measured distance to the article is less than the resolution of the coordinate values designated by the movement instruction unit 610, it is determined which of the fine movement instruction unit 604 and the operation instruction unit 605 transmits the movement instruction. However, the resolution of the coordinate values designated by the movement instruction unit 610 is an example of the threshold value of the determination, and the position determination unit 603 may use another value as the threshold value. For example, the position determination unit 603 may determine that when the measured distance is less than half of the resolution of the coordinate values designated by the movement instruction unit 610, the fine operation instruction unit 604 transmits the movement instruction, and when the measured distance is more than half of the resolution of the coordinate values designated by the movement instruction unit 610, the operation instruction unit 605 transmits the movement instruction. In the latter, the conveying vehicle 1 moves to the adjacent grid according to the movement instruction from the movement instruction unit 610, and executes measurement of the distance to the article by the measurement unit 602 in the grid of the destination and determination by the position determination unit 603.

The reception unit 606, the determination unit 607, and the control unit 608 of the conveying vehicle 1 of this embodiment may have, in addition to the above functions, the same functions as the reception unit 103, the determination unit 104, and the control unit 105 of the first embodiment. In that case, the conveying vehicle 1 of this embodiment further has the determination criteria DB.

The measurement unit 602 of the attachment 2 of this embodiment may have, in addition to the above function, the same function as the measurement unit 101 of the first embodiment. In addition, the attachment 2 of this embodiment may further have the transmission unit 102 of the first embodiment, and the fine operation instruction unit 604 and the operation instruction unit 605 may have, in addition to the above functions, the same function as the transmission unit 102.

### Fourth Embodiment

In the third embodiment, the communication between the conveying vehicle 1, the attachment 2, and the controller 3 has been described. In a fourth embodiment, a system that restricts the operation of another conveying vehicle 1 from information that is notified from the conveying vehicle 1 and the attachment 2 to the controller 3 will be described. Except for the differences described below, the portions of the conveying system of the fourth embodiment have the same functions as the portions indicated by the same reference numerals of the first to third embodiments illustrated in FIGS. 1 to 6, and their description is omitted.

FIG. 7 is a conceptual diagram illustrating the operation of the conveying vehicle 1 according to the fourth embodiment of the present invention.

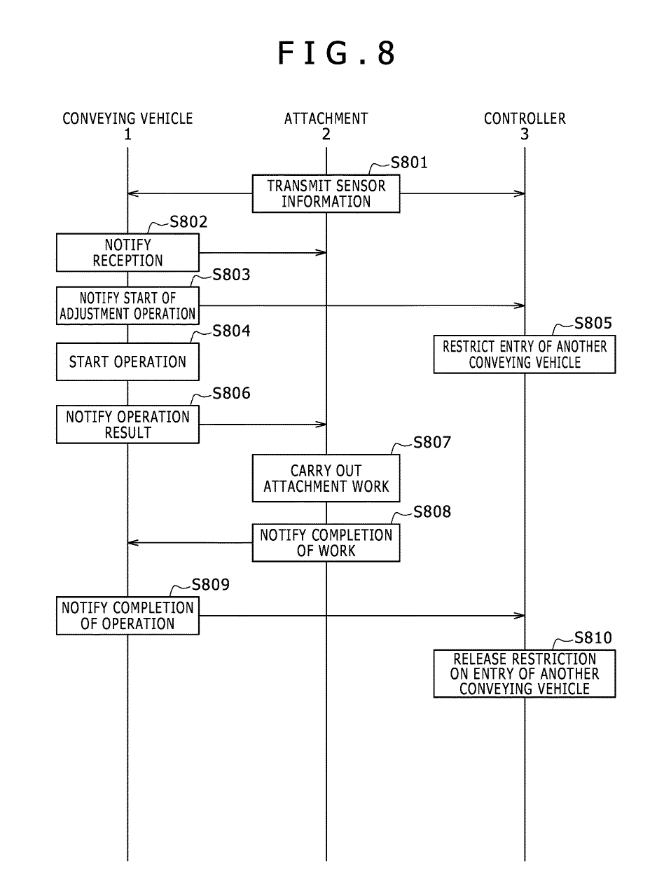

FIG. 8 is a sequence diagram illustrating communication between the conveying vehicle 1, the attachment 2, and the controller 3 according to the fourth embodiment of the present invention.

FIG. 7 illustrates an example of a plan view of a work area 700 (e.g., a space in a warehouse). The work area 700 is divided into a plurality of grids having a predetermined size (e.g., a square of 1 m×1 m), and a movement instruction transmitted by the controller 3 includes, as the coordinates values of a destination, the coordinate values of the grid. Conveying vehicles 701 and 702 illustrated in the work area 700 correspond to the conveying vehicle 1 in FIGS. 6 and 8. An attachment 706 attached to the conveying vehicle 701 corresponds to the attachment 2 in FIGS. 6 and 8. The controller 3 is not illustrated in FIG. 7, and as long as it can communicate with the conveying vehicles 701 and 702 and the attachment 706, it can be installed in any position inside and outside the work area 700.

Referring to FIG. 7, an example in which in the work area 700, the conveying vehicle 701 attaches the attachment 706 thereto to carry out a work instructed from the controller 3 will be described. In this example, the attachment 706 is a robot arm, and the instructed work is a work in which the conveying vehicle 701 and the attachment 2 hold an article stored in a rack 705 (the shaded portion) and convey it to a predetermined position.

When the conveying vehicle 701 reaches the position of a destination (e.g., a grid 703) according to the movement instruction from the movement instruction unit 610 of the controller 3, and the attachment 706 receives the work instruction from the work instruction unit 609 of the controller 3, the process in FIG. 8 is started. The conveying vehicle 1 and the attachment 2 in FIG. 8 are, e.g., the conveying vehicle 701 and the attachment 706 (that is, the robot arm) in FIG. 7, respectively.

In step S801, the attachment 2 receives sensor information of a mounted camera, and transmits it to the conveying vehicle 1. In addition, the attachment 2 transmits the sensor information to the controller 3 at the same time, and when the coordinate position movement of the conveying vehicle 1 is required, the attachment 2 notifies this.

Specifically, as described in the third embodiment, the measurement unit 602 measures a distance to the article to be worked for the instructed work, and the position determination unit 603 determines whether or not the article is within the operation range of the attachment 2 (that is, the robot arm) according to the measurement result. Here, an example in which the article is outside the operation range of the robot arm, but the distance from the robot arm to the article is less than the size of the grid (e.g., 1 m) will be described. In this case, the fine operation instruction unit 604 transmits a moving direction and a moving distance to the conveying vehicle 1. Further, the operation instruction unit 605 transmits, to the controller 3, the sensor information and a notification that the position of the conveying vehicle 1 is being finely adjusted.

In step S802, the conveying vehicle 1 receives the information transmitted by the attachment 2, and returns, to the attachment 2, a notification that the conveying vehicle 1 has received the information.

In step S803, the conveying vehicle 1 notifies, to the controller 3, that the conveying vehicle 1 starts movement for the adjustment operation according to the information from the fine operation instruction unit 604 based on the information of the moving direction and the moving distance transmitted from the attachment 2. This notification includes information of the moving direction. For example, when the moving direction of the conveying vehicle 701 in the grid 703 is the direction of a grid 704, information representing that the grid 704 is a destination is notified.

In step S804, the conveying vehicle 1 starts movement.

In step S805, the controller 3 receives, from the conveying vehicle 1, the notification that the adjustment operation is started, and restricts the entry of another conveying vehicle. For example, when as described above, the conveying vehicle 701 positioned in the grid 703 is moved in the direction of the grid 704 for the adjustment operation, this can intrude at least part of the conveying vehicle 701 into the grid 704. Consequently, when the intrusion of another conveying vehicle (e.g., the conveying vehicle 702) into the grid 704 is allowed, both of the conveying vehicles 701 and 702 can collide with each other. Thus, when the conveying vehicle 701 starts the adjustment operation, the entry of the conveying vehicle 702 into the grids 703 and 704 is restricted.

Specifically, the entry restriction is achieved for example, in such a manner that the controller 3 does not designate, as the destination of the conveying vehicle 702, the current position of the conveying vehicle 701 (in the above example, the grid 703) and the predetermined range of the moving direction (in the above example, the grid 704) and that the controller 3 transmits, to the conveying vehicle 702, an instruction that inhibits intrusion into the grids 703 and 704. The control unit 608 of the conveying vehicle 702 that has received this instruction controls the movement of the conveying vehicle 702 so that it does not intrude into the designated grid. For example, the conveying vehicle 702 selects a path that does not include the grids 703 and 704, as a moving path from the current position to the destination designated by the movement instruction unit 610. This avoids the collision of the conveying vehicles 702 and 701. Alternatively, the controller 3 may select a path that does not include the grids 703 and 704 to notify it to the conveying vehicle 702 so that the conveying vehicle 702 moves through the path. When there are a plurality of conveying vehicles other than the conveying vehicle 701, the above process is executed by the conveying vehicles and the controller 3.

In step S806, the conveying vehicle 1 transmits an operation result notification to the attachment 2.

In step S807, the attachment 2 receives this notification, and executes the work instructed from the controller 3.

In step S808, when the work of the attachment 2 is completed, the attachment 2 transmits a work completion notification to the conveying vehicle 1.

In step S809, the conveying vehicle 1 receives the notification from the attachment 2, transmits an operation completion notification to the controller 3, and notifies the current position of the conveying vehicle 1.

In step S810, the controller 3 receives the operation completion notification from the conveying vehicle 1, and releases the entry restriction on another conveying vehicle to the position other than the current position of the conveying vehicle 1. When the position of the conveying vehicle 701 after the adjustment operation is the grid 703, the entry restriction with respect to the grid 704 is released.

This can finely adjust the position of the conveying vehicle 1 according to the work of the attachment 2, and can further prevent the intrusion of another conveying vehicle during the fine adjustment.

### Fifth Embodiment

An example in which a performance restriction when the conveying vehicle attaches a plurality of attachments thereto will be described. Except for the differences described below, the portions of a conveying system of a fifth embodiment have the same functions as the portions indicated by the same reference numerals of the first to fourth embodiments illustrated in FIGS. 1 to 8, and their description is omitted.

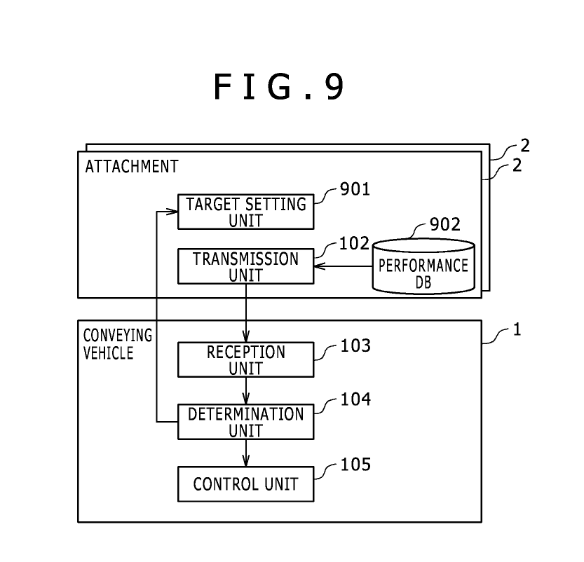

FIG. 9 is a function block diagram illustrating the configuration of the conveying system according to the fifth embodiment of the present invention.

FIG. 9 illustrates an example in which one conveying vehicle 1 attaches two attachments 2 thereto, but the conveying vehicle 1 may actually attach three or more attachments 2 thereto. Each attachment 2 has, in addition to the transmission unit 102, a target setting unit 901 and a performance database (DB) 902. Although not illustrated in FIG. 9, the attachment 2 may further have the measurement unit 101. The target setting unit 901 has a function achieved in such a manner that the processor 112 executes the program stored in the memory device 113. The performance DB 902 includes information related to the performance of the attachment 2, which is stored in the memory device 113.

The attachment 2 reads out the performance of the attachment 2 from the performance DB 902, and notifies it from the transmission unit 102 to the conveying vehicle 1. Here, the performance of the attachment 2 is, e.g., a withstand load (in the case of a robot arm, the upper limit of the weight of an article held by the arm, and in the case of a belt conveyor, the upper limit of the weight of an article that can be placed thereon), but is not limited to this.

The conveying vehicle 1 receives the information from the attachment 2 by the reception unit 103. The conveying vehicle 1, which attaches a plurality of attachments 2 thereto, receives the performance information from each attachment 2.

The determination unit 104 calculates a restriction with respect to the plurality of attachments 2 based on the received performance information. For example, when it is assumed that the withstand load of one of the attachments 2 is 10 kg, the withstand load of the other attachment 2 is 5 kg, and the two attachments carry out a work together, the determination unit 104 sets the withstand load of each of the two attachments to 5 kg. This is for setting to the safe side.

For example, when both of the two attachments 2 are robot arms, each of them may handle an article having a weight that does not exceed the withstand load as long as it independently handles the article. However, when the two robot arms are attached to one conveying vehicle, it is assumed that the robot arms lift one article together, and in that case, it is difficult to previously predict the distribution of the load applied to each of the robot arms. Due to this, in order that even when all loads are applied to the robot arm having a lower withstand load, the robot arm can withstand them, the determination unit 104 determines that the same performance value as the lower withstand load is set to the robot arms.

Here, the withstand load is given as the example of the performance, but this is ditto for other performances, and is ditto for a case where three or more attachments 2 are attached. That is, to all the attached attachments 2, the same value as the lowest one from among the performances thereof is set.

The determination unit 104 notifies the determined withstand load to the target setting unit 901 of each attachment 2 attached to the conveying vehicle 1. The target setting unit 901 sets an article to be worked. For example, when the withstand load is set to 5 kg, and the article to be worked notified from the controller 3 exceeds 5 kg, a notification that the article is not to be worked is notified to the controller 3. When a measurement device is mounted as the sensor 111 on the attachment 2, it may measure the weight of an article, and when a camera is mounted as the sensor 111, it may identify and obtain information of the weight of an article printed on the article.

In this manner, when a plurality of attachments 2 are mounted on one conveying vehicle, they are controlled so as not to exceed the lowest one of the performances of the attachments 2. Thus, the criteria on the safe side are imposed on all the attachments 2 so that the work can be safely carried out.

The reception unit 103, the determination unit 104, and the control unit 105 of the conveying vehicle 1 of this embodiment further have the functions described in the first embodiment. Although not illustrated in FIG. 9, the conveying vehicle 1 of this embodiment further has the determination criteria DB 106. In addition, although not illustrated in FIG. 9, each attachment 2 of this embodiment further has the measurement unit 101 described in the first embodiment.

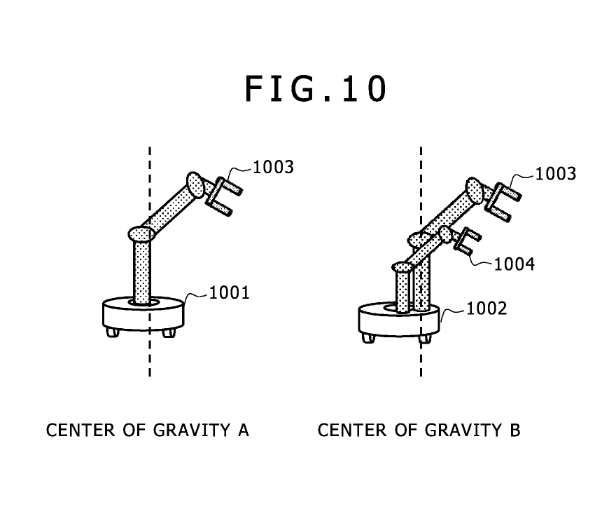

An example in which when a plurality of attachments 2 are attached to the conveying vehicle 1, the work determination of a target article is carried out by using the center of gravity will be described with reference to FIG. 10.

FIG. 10 is an explanatory view of the center of gravity when one or more attachments 2 are attached to the conveying vehicle 1 according to the fifth embodiment of the present invention.

Conveying vehicles 1001 and 1002 illustrated in FIG. 10 correspond to the conveying vehicle 1 illustrated in FIG. 9. Robot arms 1003 and 1004 illustrated in FIG. 10 are an example of the attachment 2 illustrated in FIG. 9.

One robot arm 1003 is mounted on the conveying vehicle 1001. In this case, the center of gravity of an entire moving body in which the conveying vehicle 1001 and the robot arm 1003 are integrated can be represented by the center of gravity A.

When two robot arms 1003 and 1004 are mounted on the conveying vehicle 1002, the center of gravity of an entire moving body in which the conveying vehicle 1002 and the robot arms 1003 and 1004 are integrated can be represented by the center of gravity B. When the withstand load of the robot arm 1003 is 10 kg, the determination unit 104 of the conveying vehicle 1001 determines the center of gravity position of the entire moving body including the conveying vehicle 1001 and the robot arm 1003, and can determine that it can lift an article of 10 kg that is the withstand load of the robot arm 1003. The determination unit 104 of the conveying vehicle 1002 calculates the center of gravity position of the entire moving body including the conveying vehicle 1002 and the robot arms 1003 and 1004, from the positions of the robot arms 1003 and 1004, and calculates a tilt of the conveying vehicle 1002 when the article of 10 kg is lifted. When the tilt is equal to or above a threshold value, the conveying vehicle 1002 can turn over on its side. Thus, a value less than 10 kg is set as the withstand load of the robot arm 1003 so that the tilt is equal to or below the threshold value. The value to be set is calculated by the determination unit 104. Alternatively, a relationship between the previously determined center of gravity and the load may be extracted from the determination criteria DB 106.

Specifically, for example, the performance DB 902 of each attachment 2 may include, in addition to the performance of the attachment 2, information representing its own weight and the center of gravity position of the attachment 2 (in particular, the relative position of the center of gravity with respect to the attachment fitting portion 304 of the conveying vehicle 1 into which the attachment 2 is fitted), and the position of the portion attaching the article thereto (e.g., the position of the hand of the robot arm), and the transmission unit 102 may transmit the information to the conveying vehicle 1. In the case of the attachment 2 that is deformed with the movement of the center of gravity position like the robot arm, this information may include information representing a relationship between the shape and the center of gravity position of the attachment 2 and the position of the hand.

In the conveying vehicle 1, information, such as its own weight, the center of gravity position, and the position of the grounding point of the conveying vehicle 1 (e.g., the position of the wheel) is stored in the memory device 109, and the determination unit 104 can calculate the center of gravity position of an entire moving body including the conveying vehicle 1 and one or more attachments 2 attached thereto based on those information and the information transmitted from each attachment 2, thereby calculating a tilt when the article is placed on each attachment 2 based on the calculation result and the weight of the article placed on the attachment 2. The tilt can be calculated by any known method, and the description of its detailed calculation method is omitted.

As described above, the determination unit 104 can set the withstand load of each attachment 2 so that the calculated tilt does not exceed a predetermined threshold value stored as determination criteria in the determination criteria DB 106. Further, the determination unit 104 may restrict the performance of the conveying vehicle 1 when the center of gravity calculation result satisfies a predetermined condition stored as determination criteria in the determination criteria DB 106. For example, the determination unit 104 may restrict the moving speed to equal to or below a predetermined value when the calculated tilt exceeds the predetermined threshold value (that may be a value different from the threshold value for setting the withstand load) or when the calculated center of gravity position is within a predetermined range. In that case, for example, the determination criteria DB 106 includes determination criteria as to whether or not the performance is restricted based on the center of gravity calculation result for each attribute (e.g., type) of the attachment, and the determination unit 104 carries out the above determination according to the determination criteria.

Thus, when the conveying vehicle 1 attaches a plurality of attachments 2 thereto, the work and movement can be carried out without turning over the conveying vehicle 1 on its side due to the work load.

In the above example, the case where the conveying vehicle 1 attaches a plurality of attachments 2 thereto has been described, and when the conveying vehicle 1 attaches one attachment 2 thereto, the moving speed of the conveying vehicle 1 may be restricted based on the center of gravity position of the moving body (e.g., based on the tilt when the object is placed). Thus, in particular, when the attachment 2 that is deformed with the center of gravity movement like the robot arm is attached, the conveying vehicle 1 can be prevented from turning over on its side.

The present invention has been described above, but is not limited to the above embodiments, and includes various modifications. For example, the above embodiments have been described in detail to easily understand the present invention, and do not necessarily have all the described configurations. In addition, part of the configuration of one of the embodiments can be replaced by the configuration of the other embodiments, and the configuration of one of the embodiments can be added with the configurations of the other embodiments. Further, part of the configuration of each embodiment can be added with, deleted from, and replaced by the other configurations.

Here, a representative modification of the above embodiments will be described.

In the above embodiments, as the example of the restriction on the movement of the conveying vehicle 1, the restriction on the moving speed and the restriction on the moving path are shown, but other restrictions can be carried out. For example, to prevent the article from dropping or the conveying vehicle 1 from turning over on its side, instead of the moving speed (or in addition to the moving speed), the acceleration of the conveying vehicle 1 may be restricted. Alternatively, for example, when the type of the attachment 2 is a belt conveyor, and the attachment 2 is coupled to a belt conveyor attached to at least another conveying vehicle 1 to form one long belt conveyor, the movement of the conveying vehicle 1 may be restricted so as to hold the distance between the conveying vehicle 1 and the adjacent conveying vehicle 1 constant. For example, when the attachment 2 has, as the sensor 111, a distance measurement device that measures a distance between the conveying vehicle 1 and the adjacent conveying vehicle 1, the determination criteria DB 106 includes information representing a predetermined distance between the conveying vehicle 1 and the adjacent conveying vehicle 1 as determination criteria corresponding to the belt conveyor, and the belt conveyor is attached as the attachment 2, the determination unit 104 may determine that the movement of the conveying vehicle 1 is required to be restricted based on the determination criteria DB 106, and the control unit 105 may control the movement of the conveying vehicle according to the determination. Thus, the attachment 2 can appropriately exhibit the function of the belt conveyor.

Alternatively, when the driving device 110 of the conveying vehicle 1 includes a motor and a battery that supplies electric power thereto, a moving distance may be restricted according to the weight of an article or the attachment 2 itself in order to prevent the conveying vehicle 1 from being stopped due to the consumption of the battery. For example, the determination criteria DB 106 may include information that associates the weight of the attachment 2 itself, with the weight of an article and a moving distance, and the determination unit 104 may determine that the moving distance of the conveying vehicle 1 is restricted, based on information from the reception unit 103. Alternatively, when the attachment 2 is a lifter only for a heavy object, the determination criteria DB 106 may include information representing that a moving distance is restricted to equal to or below a predetermined value regardless of the weight of an article, and when a lifter only for a heavy object is attached, the determination unit 104 may determine that the moving distance of the conveying vehicle 1 is restricted to equal to or below the predetermined value, based on information from the reception unit 103. Thus, the non-intended stop of the conveying vehicle 1 due to the consumption of the battery can be prevented.

In the above embodiments, as the example of the attribute of the attachment 2, the type of the attachment 2 is given, but the determination criteria DB 106 may include determination criteria for each attribute other than the type of the attachment 2, and the determination unit 104 may restrict the movement of the conveying vehicle 1 according to the determination criteria. Specifically, for example, as illustrated in FIG. 4, when the size of an article that can pass is restricted, the size of the article that is placed on the attachment 2 and can pass is different according to the size of the attachment 2 itself. For this, the determination criteria DB 106 may include information that associates the size of each attachment 2 with the size of the article that is placed on the attachment 2 and can pass. Alternatively, when as described above, the moving distance of the conveying vehicle 1 is restricted due to the consumption of the battery, the determination criteria DB 106 may include information that associates the weight of the attachment 2 with the weight of the article and the restriction on the moving distance.

Further, in the above embodiments, the measurement unit 101 measures the weight or size of an article, and the transmission unit 102 transmits the result to the conveying vehicle 1, but the attachment 2 may transmit any information as long as it is information that can be used for identifying its attribute such as the weight or size of the article. For example, when a letter or barcode representing the weight of an article is shown on the surface of the article, the measurement unit 101 may read the letter and the like, and the transmission unit 102 may transmit the weight of the article obtained therefrom. Alternatively, when a letter or barcode including identification information of an article is shown on the surface of the article, and the attachment 2 or the conveying vehicle 1 holds information that associates identification information of the article with the weight of the article, the measurement unit 101 may read the identification information, and the attachment 2 or the conveying vehicle 1 may identify the weight of the article based thereon.

The functions of the conveying system may be achieved by hardware in such a manner that they are designed into, e.g., an integrated circuit in whole or in part. In addition, the functions of the processor may be achieved by software in such a manner that the processor interprets and executes the program that achieves the functions. Information, such as a program, table, and file, that achieves each function, can be stored in a recording device, such as a memory, hard disk, and SSD (Solid State Drive) or in a calculator-readable non-temporary data recording medium, such as an IC card, SD card, or DVD (Digital Versatile Disc).

The drawings illustrate the control lines and the information lines that are considered to be required for describing the embodiments, and do not necessarily illustrate all control lines and information lines included in an actual product to which the present invention is applied. Actually, almost all the configurations may be considered to be mutually connected.

1.-2. (canceled)

3. A conveying vehicle that loads an article thereon and moves comprising:
an attachment fitting portion into which an attachment having a predetermined function is fitted;
a memory device that stores determination criteria as to the presence or absence of a restriction on the movement of the conveying vehicle corresponding to the attribute of the attachment;
a reception unit that receives information related to the attribute of the attachment from the attachment fitted into the attachment fitting portion;
a determination unit that determines whether or not the restriction on the movement of the conveying vehicle is required, based on the determination criteria corresponding to the attribute of the attachment identified from the information received by the reception unit; and
a control unit that controls the movement of the conveying vehicle according to the restriction when it is determined that the restriction is required,
wherein the memory device further includes map information,
wherein the determination criteria corresponding to the attribute of the attachment include information that associates the size of an article loaded on the conveying vehicle with information as to whether or not the conveying vehicle can pass through a path included in the map information,
wherein the reception unit receives information related to the size of the article from the attachment,
wherein the determination unit determines whether or not the conveying vehicle can pass through the path included in the map information, based on the size of the article identified based on the information received by the reception unit and the determination criteria, and transmits position information that indicates a position through which the conveying vehicle can pass, and
wherein control unit restricts the path through which the conveying vehicle moves based on the position information.

4. The conveying vehicle according to claim 3,
wherein the determination criteria corresponding to the attribute of the attachment include information representing the upper limit of the moving distance of the conveying vehicle, and
wherein the determination unit determines whether or not the moving distance of the conveying vehicle is required to be restricted, based on the determination criteria.

5. The conveying vehicle according to claim 3,
wherein the determination criteria corresponding to the attribute of the attachment include information representing a predetermined distance between the conveying vehicle and another conveying vehicle, and
wherein the determination unit determines whether or not a distance between the conveying vehicle and another conveying vehicle is required to be controlled so as to be the predetermined distance, based on the determination criteria.

6. The conveying vehicle according to claim 3,
wherein the conveying vehicle has one or more attachment fitting portions,
wherein the memory device stores a determination condition of the restriction on the movement of the conveying vehicle based on the center of gravity position of an entire moving body including the conveying vehicle and one or more attachments fitted into the one or more attachment fitting portions,
wherein when the one or more attachments are fitted into the one or more attachment fitting portions, the reception unit receives, from each of the one or more attachments, information related to the weight and the center of gravity position of the attachment, and
wherein the determination unit calculates the center of gravity position of the entire moving body including the conveying vehicle and the one or more attachments based on the weight and the center of gravity position of each of the one or more attachments identified from the information received by the reception unit and the weight and the center of gravity position of the conveying vehicle, and determines whether or not the restriction on the movement of the conveying vehicle is required, based on the center of gravity position of the entire moving body and the determination condition.

7. The conveying vehicle according to claim 6,
wherein the reception unit receives, from the one or more attachments, information related to the weight of the article, and
wherein the determination unit calculates a tilt of the moving body based on the center of gravity position of the entire moving body and the weight of the article, and determines that when the tilt exceeds a value set as the determination condition, at least one of the moving speed and the acceleration of the conveying vehicle is required to be restricted.

8. The conveying vehicle according to claim 3,
wherein the information related to the attribute of the attachment includes at least one of the identification information, type, weight, size, function, and application of the attachment.

9. A conveying system that has a conveying vehicle that loads an article thereon and moves and an attachment attached to the conveying vehicle,
wherein the attachment has a transmission unit that transmits information related to the attribute of the attachment, and
wherein the conveying vehicle has:
an attachment fitting portion into which the attachment is fitted;
a memory device that stores determination criteria as to the presence or absence of a restriction on the movement of the conveying vehicle corresponding to the attribute of the attachment;
a reception unit that receives the information related to the attribute of the attachment from the attachment fitted into the attachment fitting portion;
a determination unit that determines whether or not the restriction on the movement of the conveying vehicle is required, based on the determination criteria corresponding to the attribute of the attachment identified from the information received by the reception unit; and
a control unit that controls the movement of the conveying vehicle according to the restriction when it is determined that the restriction is required,
wherein the memory device further includes map information,
wherein the determination criteria corresponding to the attribute of the attachment include information that associates the size of the article loaded on the conveying vehicle with information as to whether or not the conveying vehicle can pass through a path included in the map information,
wherein the reception unit receives information related to the size of the article loaded on the conveying vehicle from the attachment,
wherein the determination unit determines whether or not the conveying vehicle can pass through the path included in the map information, based on the size of the article identified based on the information received by the reception unit and the determination criteria, and transmits position information that indicates a position through which the conveying vehicle can pass, and
wherein control unit restricts the path through which the conveying vehicle moves based on the position information.

10. The conveying system according to claim 9,
wherein the conveying vehicle has a plurality of attachment fitting portions,
wherein the conveying system has a plurality of the attachments fitted into the plurality of attachment fitting portions,
wherein each of the attachments further has a memory device that stores performance information of each of the attachments,
wherein the transmission unit of each of the attachments transmits the performance information of each of the attachments to the conveying vehicle,
wherein the determination unit transmits, to each of the attachments, the performance of the attachment having the lowest performance from among the plurality of attachments, based on the performance information of the attachment, and
wherein the operation of each of the attachments is controlled so that the attachment does not exceed the performance received from the conveying vehicle.

11. The conveying system according to claim 9,
wherein the conveying system further has a control device that communicates with the attachment and the conveying vehicle,
wherein the control device has a movement instruction unit that transmits, to the conveying vehicle, a movement instruction including the coordinate values of a destination, and a work instruction unit that transmits, to the attachment, a work instruction targeting the article,
wherein the attachment has an instruction reception unit that receives the work instruction from the work instruction unit, a measurement unit that measures a distance from the attachment to the article, a position determination unit that determines, based on the distance, whether or not the article is within the operation range of the attachment, and compares the distance with a predetermined threshold value when the article is not within the operation range, a first operation instruction unit that transmits, to the conveying vehicle, the movement instruction to the direction of the article when the distance is less than the predetermined threshold value, and a second operation instruction unit that transmits, to the control device, the movement instruction to the direction of the article when the distance is equal to or above the predetermined threshold value,
wherein when the movement instruction unit of the control device receives the movement instruction from the second operation instruction unit, the unit transmits, to the conveying vehicle, the movement instruction to the direction of the article according to the received movement instruction,
wherein the reception unit of the conveying vehicle receives the movement instruction from the first operation instruction unit or the movement instruction unit, and
wherein the control unit controls the movement of the conveying vehicle according to the received movement instruction.

12. The conveying system according to claim 11,
wherein the predetermined threshold value is the resolution of the coordinate values instructed by the movement instruction unit.

13. The conveying system according to claim 11,
wherein the conveying system includes a plurality of conveying vehicles,
wherein when the distance is less than the predetermined value, the second operation instruction unit of each of the conveying vehicles transmits, to the control device, a notification that the conveying vehicle moves to the direction of the article,
wherein the movement instruction unit transmits, to a conveying vehicle other than the conveying vehicle that has transmitted the notification, an instruction that inhibits intrusion into a predetermined range in the notified moving direction, and
wherein the control unit of each of the conveying vehicles controls the movement of the conveying vehicle so that the conveying vehicle does not intrude into the predetermined range according to the instruction transmitted from the movement instruction unit.

14. A conveying vehicle that loads an article thereon and moves, comprising:
an attachment fitting portion into which an attachment having a predetermined function is fitted;
a memory device that stores determination criteria as to the presence or absence of a restriction on the movement of the conveying vehicle corresponding to the attribute of the attachment;
a reception unit that receives information related to the attribute of the attachment from the attachment fitted into the attachment fitting portion;
a determination unit that determines whether or not the restriction on the movement of the conveying vehicle is required, based on the determination criteria corresponding to the attribute of the attachment identified from the information received by the reception unit; and
a control unit that controls the movement of the conveying vehicle according to the restriction when it is determined that the restriction is required,
wherein the determination criteria corresponding to the attribute of the attachment include information that associates, according to the attribute of the attachment, the weight of an article loaded on the conveying vehicle with the upper limit of at least one of the moving speed and the acceleration of the conveying vehicle,
wherein the reception unit receives information related to the weight of the article from the attachment, and
wherein the determination unit determines whether or not at least one of the moving speed and the acceleration of the conveying vehicle is required to be restricted, based on the weight of the article identified based on the information received by the reception unit and the determination criteria.
